(19) United States
(12) Patent Application Publication
(10) Pub. No.: US 2021/0159752 A1
(43) Pub. Date: May 27, 2021

(54) MOTOR

(71) Applicant: GRENERGY OPTO, INC., Hsinchu City (TW)

(72) Inventors: SHAN-NAN CHEN, Hsinchu City (TW); SHENG-WEN CHEN, Hsinchu City (TW)

(21) Appl. No.: 16/865,522

(22) Filed: May 4, 2020

(30) Foreign Application Priority Data
Nov. 27, 2019 (TW) 108143231

(51) Int. Cl. H02K 5/10

(52) U.S. Cl. CPC H02K 5/10

(57) ABSTRACT

A motor, into which air in an external environment is blocked from flowing, is provided. The motor includes a motor main body, a gas collection element and a protection component. The motor main body has a chamber. The gas collection element is disposed outside the motor main body and has a gas collection space. The gas collection space is only communicated with the chamber and allows gas to be exchanged between the gas collection space and the chamber. The protection component is disposed outside of the motor main body and used to protect the gas collection element.

### CROSS-REFERENCE TO RELATED PATENT APPLICATION

This application claims the benefit of priority to Taiwan Patent Application No. 108143231, filed on Nov. 27, 2019. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a motor, and more particularly to a motor into which air in an external environment is blocked from flowing is provided.

### BACKGROUND OF THE DISCLOSURE

When a current flows through a coil of a running motor, heat is generated due to thermal effects. As a result, a temperature of the motor rises and a gas in the motor is heated to expand. The heated gas flows to an external environment to balance air pressure between a chamber of the motor and the external environment. However, when the motor stops running, the temperature of the motor is gradually reduced such that the gas is shrunk and the air pressure in the motor is reduced. At this time, if the motor is disposed at a seaside location, cold air rich in salt and water would flow from the external environment into the motor. As a result, an operating efficiency of the motor is reduced, and the motor may even be damaged.

### SUMMARY OF THE DISCLOSURE

In response to the above-referenced technical inadequacies, the present disclosure provides a motor, into which air in an external environment is blocked from flowing. The motor includes a motor main body, a gas collection element and a protection component. The motor main body has a chamber. The gas collection element is disposed outside the motor main body. The gas collection element has a gas collection space that is only communicated with the chamber. Gas is allowed to be exchanged between the gas collection space and the chamber. The protection component is disposed outside the motor main body and used to protect the gas collection element.

In certain embodiments, the gas collection element includes a balloon or a gasbag.

In certain embodiments, the motor main body is connected to a controller used to control the motor main body.

In certain embodiments, the controller is accommodated in the protection component.

In certain embodiments, the protection component has an accommodation space in which the gas collection element is accommodated.

In certain embodiments, the protection component includes a cover body disposed at one side of the motor main body, and the gas collection element is accommodated in the cover body.

In certain embodiments, the protection component includes a box body disposed outside the motor main body, and the gas collection element is accommodated in the box body.

In certain embodiments, the motor main body has a through hole penetrating through the motor main body, and the chamber of the motor main body is communicated with the gas collection space of the gas collection element through the through hole.

As described above, the present disclosure provides the motor, into which air in the external environment is blocked from flowing. The gas collection element is disposed outside the motor main body. The gas is exchanged between the gas collection element and the chamber of the motor main body. The air in the external environment is blocked from flowing into the chamber of the motor main body. The gas in the chamber of the motor main body is not permitted to be exchanged with the air in the external environment. Therefore, the cold air rich in salt, water or other impurities can be prevented from clinging on the transmission shaft or other components of the motor to affect the operation of the motor, thereby extending a lifetime of the motor.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of a balloon of a motor being expanded from collecting gas in a motor main body of the motor according to a first embodiment of the present disclosure.

FIG. 2 is a schematic view of a balloon of the motor being shrunken from having the gas collected within flow back to the motor main body according to the first embodiment of the present disclosure.

FIG. 3 is an exploded view of the motor according to a second embodiment of the present disclosure.

FIG. 4 is an assembled view of the motor according to the second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

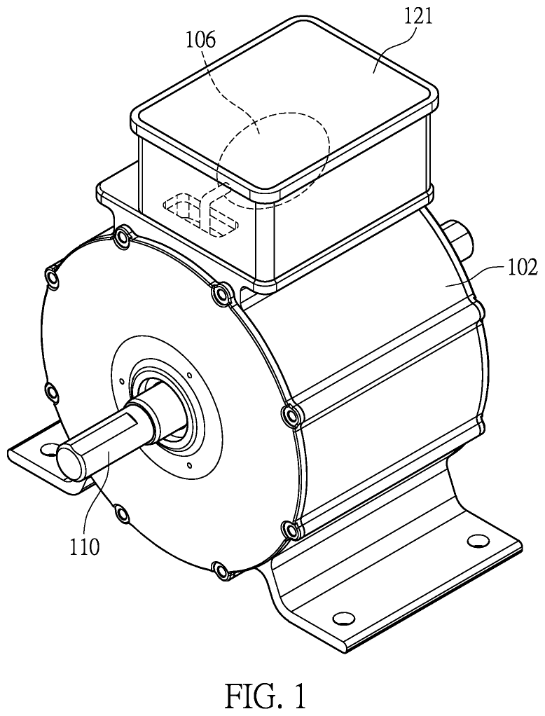

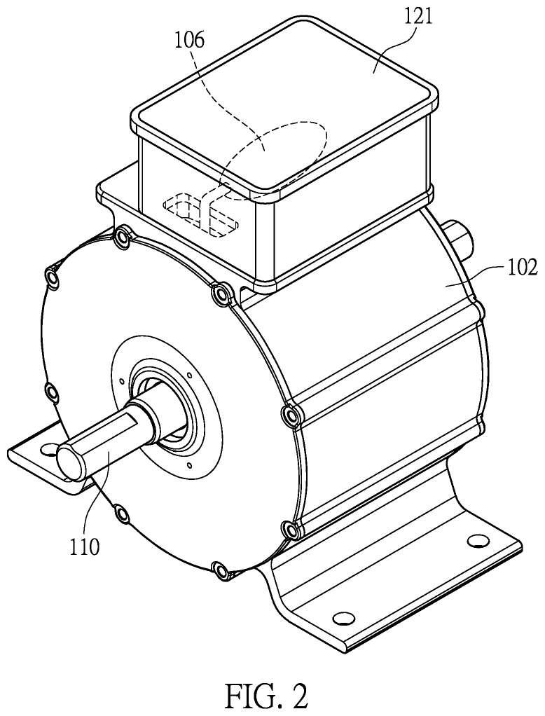

Reference is made to FIGS. 1 and 2, wherein FIG. 1 is a schematic view of a balloon of a motor being expanded from collecting gas in a motor main body of the motor according to a first embodiment of the present disclosure, and FIG. 2 is a schematic view of a balloon of the motor being shrunken from having the gas collected within flow back to the motor main body according to the first embodiment of the present disclosure.

As shown in FIGS. 1 and 2, in the embodiment, the motor includes a motor main body 102, a gas collection element 106 and a protection component. The motor main body 102 may be a DC brushless motor, but the disclosure is not limited thereto.

It is worth noting that, when the motor is disposed at a seaside location, air is exchanged between a chamber of the motor main body 102 and the external environment, during which cold air rich in salt and water flows into the chamber. As a result, an operating efficiency of the motor is reduced, and the motor may even be damaged. Therefore, in the embodiment, the gas collection element 106 is disposed outside the motor main body 102, and is such as a balloon or a gasbag. The gas is exchanged between a gas collection space of the gas collection element 106 and the chamber of the motor main body 102.

The protection component 121 is disposed outside the motor main body 102 and used to protect the gas collection element 106. In the embodiment, the protection component 121 may be a box body and is disposed outside the motor main body 102. For example, the protection component 121 may be disposed on the motor main body 102. The gas collection element 106 may be accommodated in the box body of the protection component 121, and the box body is closed by a lid, thereby protecting the gas collection element 106 from being damaged by external environmental factors. It should be understood that, the present disclosure is not limited to the configurations and types of the components exemplified in the embodiments. In practice, the gas collection element 106 may be disposed at any position outside the motor main body 102 according to practical requirements.

A control box of the motor may be used as the box body of the protection component 121. The gas collection element 106 and a controller for controlling the motor main body 102 may be accommodated in the control box of the motor, but present disclosure is not limited thereto. It should be understood that, in practice, the gas collection element 106 and the controller may be respectively disposed in different accommodation spaces or in the same accommodation space according to application requirements.

The motor main body 102 may have a through hole penetrating through a housing of the motor main body 102. The chamber of the motor main body 102 is only communicated with the gas collection space of the gas collection element 106 via the through hole. The air in the external environment is blocked from flowing into the motor main body 102. The gas in the chamber of the motor main body 102 is only allowed to flow to the gas collection space of the gas collection element 106, and the gas in the gas collection space is only allowed to flow into the motor main body 102.

In detail, a temperature of the motor main body 102 gradually rises a transmission shaft 110 of the motor main body 102 is in operation, and the gas in the motor main body 102 is thereby heated to expand. At this time, the gas collection element 106 is communicated with the chamber inside the housing of the motor main body 102 such that the heated gas flows into the gas collection element 106 from the chamber. As shown in FIG. 1, a volume of the gas collection element 106 increases with as an amount of the gas in the gas collection element 106 is increased.

When a running speed of the motor main body 102 is reduced (e.g., to zero), the temperature of the motor main body 102 is gradually decreased such that the gas in the motor main body 102 is shrunk. At this time, the gas flows back to the chamber of the motor main body 102 from the gas collection element 106. As shown in FIG. 2, the volume of the gas collection element 106 becomes smaller as the amount of gas in the gas collection element 106 is decreased.

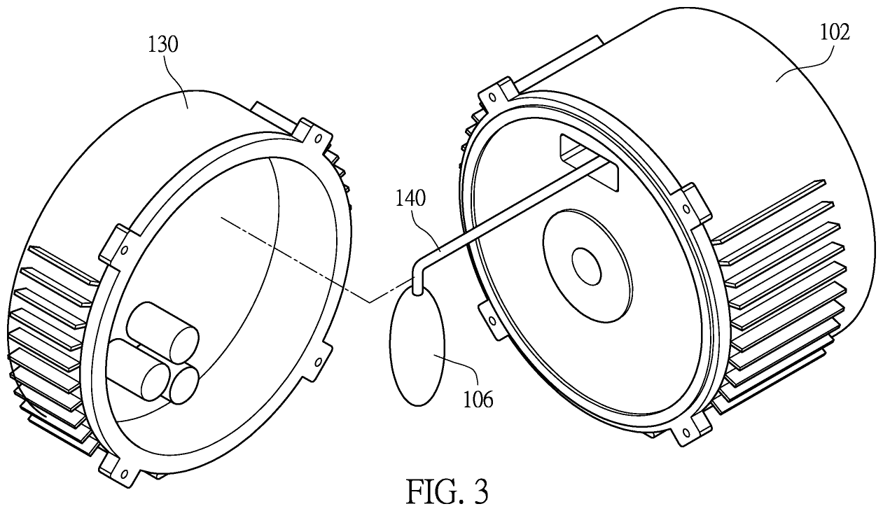

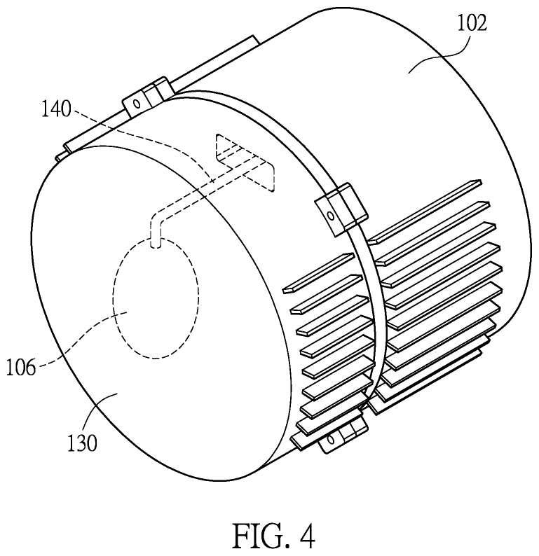

Reference is made to FIGS. 3 and 4, wherein FIG. 3 is an exploded view of the motor according to a second embodiment of the present disclosure, and FIG. 4 is an assembled view of the motor according to the second embodiment of the present disclosure.

A difference between the first and second embodiments is that, the protection component 130 may be a cover body such as a rear cover in the second embodiment. The cover body is disposed at one side of the motor main body 102. The protection component 130 has an accommodation space. The gas collection element 106 such as the balloon or the gasbag and circuit components for controlling the motor main body 102 may be accommodated in the accommodation space of the protection component 130. It should be understood that, the present disclosure is not limited to the configurations and types of the components exemplified in the embodiments. In practice, the gas collection element 106 may be disposed at any position outside of the motor main body 102 according to practical requirements.

The motor main body 102 may have a through hole penetrating through the motor main body 102. A gas pipe 140 may be selectively disposed. The gas pipe 140 may pass through the through hole. The gas collection space of the gas collection element 106 may be communicated with the chamber of the motor main body 102 through the gas pipe 140. The air in the external environment is blocked from flowing into the motor and the gas in the chamber of the motor main body 102 is blocked from flowing to the external environment. Therefore, the gas is only allowed to be exchanged between the chamber of the motor main body 102 and the gas collection space of the gas collection element 106.

In detail, when the transmission shaft 110 of the motor main body 102 runs for a long time, the temperature of the motor main body 102 gradually rises such that the volume of the gas in the motor main body 102 is heated to expand. At this time, the gas in the housing of the motor main body 102 flows into the gas collection element 106 to conduct heat into the gas collection element 106 to balance air pressure. As shown in FIG. 1, the volume of the gas collection element 106 increases with an increase in the amount of the gas in the gas collection element 106.

When the running speed of the motor main body 102 is reduced (to zero), the temperature of the motor main body 102 gradually decreases such that the gas in the motor main body 102 is shrunk. At this time, the gas in the gas collection element 106 flows back to the chamber of the motor main body 102 to balance air pressure. As shown in FIG. 2, the volume of the gas collection element 106 decreases with a decrease in the amount of gas in the gas collection element 106.

In summary, the present disclosure provides the motor, into which air in the external environment is blocked from flowing. The gas collection element is disposed outside the motor main body. The gas is exchanged between the gas collection element and the chamber of the motor main body. The air in the external environment is blocked from flowing into the chamber of the motor main body. The gas in the chamber of the motor main body is not allowed to be exchanged with the air in the external environment. Therefore, the cold air rich in salt, water or other impurities can be prevented from clinging on the transmission shaft or other components of the motor to affect the operation of the motor, thereby extending a lifetime of the motor.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A motor, into which air in an external environment is blocked from flowing,
the motor comprising:
a motor main body having a chamber;
a gas collection element disposed outside the motor main body, and having a gas collection space that is communicated only with the chamber, wherein gas is allowed to be exchanged between the gas collection space and the chamber; and
a protection component disposed outside the motor main body and used to protect the gas collection element.

2. The motor according to claim 1, wherein the gas collection element includes a balloon or a gasbag.

3. The motor according to claim 1, wherein the motor main body is connected to a controller used to control the motor main body.

4. The motor according to claim 3, wherein the controller is accommodated in the protection component.

5. The motor according to claim 1, wherein the protection component has an accommodation space in which the gas collection element is accommodated.

6. The motor according to claim 1, wherein the protection component includes a cover body disposed at one side of the motor main body, and the gas collection element is accommodated in the cover body.

7. The motor according to claim 1, wherein the protection component includes a box body disposed outside of the motor main body, and the gas collection element is accommodated in the box body.

8. The motor according to claim 1, wherein the motor main body has a through hole penetrating through the motor main body, and the chamber of the motor main body is communicated with the gas collection space of the gas collection element through the through hole.
